(19) United States
(12) Patent Application Publication
(10) Pub. No.: US 2025/0139875 A1
(43) Pub. Date: May 1, 2025

(54) IMAGE GENERATION METHOD AND APPARATUS

(71) Applicant: Lenovo (Beijing) Limited, Beijing (CN)

(72) Inventors: Yalei GUO, Beijing (CN); Jing FAN, Beijing (CN); Zhenfei ZHANG, Beijing (CN)

(21) Appl. No.: 18/924,996

(22) Filed: Oct. 23, 2024

(30) Foreign Application Priority Data
Oct. 31, 2023 (CN) 202311434519.6

(51) Int. Cl. G06T 15/20

(52) U.S. Cl. CPC G06T 15/20

(57) ABSTRACT

The present disclosure discloses an image generation method. The method includes: obtaining density information by a target model corresponding to a target scene space; determining a first constraint condition based on the density information; determining a target viewpoint from the target scene space based on the first constraint condition; and rendering the viewpoint image corresponding to the target viewpoint by the target model. Where the target model is trained to output a viewpoint image corresponding to any viewpoint after inputting the any viewpoint in the target scene space, the density information is a rendering parameter required for image rendering by the target model, and the density information represents transparency of a point in the target scene space.

### CROSS-REFERENCES TO RELATED APPLICATIONS

The present disclosure claims priority to Chinese Patent Application No. 202311434519.6, filed on Oct. 31, 2023, the content of which is incorporated herein by reference in its entirety.

### TECHNICAL FIELD

The present disclosure relates to the field of image processing, and more specifically, relates to an image generation method and apparatus.

### BACKGROUND

When using a model to render an image of a target scene space, the rendering viewpoint is determined within the target scene space. The existing technology does not impose any constraints on the rendering viewpoint, resulting in poor image quality in the final rendering. Some images may fail to fully represent the designated target (for example, objects in the target scene space may be missing or omitted from the image).

### SUMMARY

One aspect of the present disclosure provides an image generation method. The method includes: obtaining density information by a target model corresponding to a target scene space, determining a first constraint condition based on the density information, determining a target viewpoint from the target scene space based on the first constraint condition, and rendering the viewpoint image corresponding to the target viewpoint by the target model. The target model is trained to output a viewpoint image corresponding to any viewpoint after inputting the any viewpoint in the target scene space, the density information is a rendering parameter required for image rendering by the target model, and the density information represents transparency of a point in the target scene space.

Another aspect of the present disclosure provides an electronic device. The electronic device includes one or more processors and a memory containing a computer program that, when being executed, causes the one or more processors to: obtain density information by a target model corresponding to a target scene space, the target model being trained to output a viewpoint image corresponding to any viewpoint after inputting the any viewpoint in the target scene space, and the density information being a rendering parameter required for image rendering by the target model, and the density information representing transparency of a point in the target scene space; determine a first constraint condition based on the density information; determine a target viewpoint from the target scene space based on the first constraint condition; and render a viewpoint image corresponding to the target viewpoint by the target model.

Another aspect of the present disclosure provides a non-transitory computer-readable storage medium storing a computer program that, when being executed, causes at least one processor to perform: obtaining density information by a target model corresponding to a target scene space, where the target model is trained to output a viewpoint image corresponding to any viewpoint after inputting the any viewpoint in the target scene space; and the density information is a rendering parameter required for image rendering by the target model, and the density information represents transparency of a point in the target scene space; determining a first constraint condition based on the density information; determining a target viewpoint from the target scene space based on the first constraint condition; and rendering the viewpoint image corresponding to the target viewpoint by the target model.

### BRIEF DESCRIPTION OF THE DRAWINGS

In order to more clearly illustrate the technical solutions in the embodiments of the present disclosure or the prior art, the drawings required in the description of the embodiments or prior art will be briefly introduced below. It is evident that the drawings described below are merely some embodiments of the present disclosure, and for those skilled in the art, other drawings may be obtained without creative effort based on these drawings.

FIG. 1 is a flowchart illustrating an image generation method according to an embodiment of the present disclosure;

FIG. 2 is a schematic diagram of a viewpoint image according to an embodiment of the present disclosure;

FIG. 3 is a flowchart illustrating another image generation method according to an embodiment of the present disclosure;

FIG. 4 is a flowchart illustrating another image generation method according to an embodiment of the present disclosure;

FIG. 5 is a flowchart illustrating another image generation method according to an embodiment of the present disclosure;

FIG. 6 is a flowchart illustrating another image generation method according to an embodiment of the present disclosure;

FIG. 7 is a flowchart illustrating another image generation method according to an embodiment of the present disclosure;

FIG. 8 is a flowchart illustrating another image generation method according to an embodiment of the present disclosure; and

FIG. 9 is a schematic diagram of the architecture of an image generation apparatus according to an embodiment of the present disclosure.

### DETAILED DESCRIPTION

The technical solutions in the embodiments of the present disclosure will be clearly and fully described in conjunction with the accompanying drawings. It is evident that the described embodiments are merely a part of the embodiments of the present disclosure, not all of the embodiments. Based on the embodiments of the present disclosure, all other embodiments obtained by those skilled in the art without creative effort shall fall within the scope of protection of the present disclosure.

In the present disclosure, relational terms such as “first” and “second” are only used to distinguish one entity or operation from another entity or operation, and do not necessarily imply any actual relationship or order between these entities or operations. The terms “comprise,” “include,” or any variations thereof are intended to cover non-exclusive inclusion, such that a process, method, article, or apparatus that includes a set of elements not only includes those elements but may also include other elements not explicitly listed or elements inherent to such a process, method, article, or apparatus. In the absence of further limitations, elements defined by the phrase “comprising a . . . ” do not exclude the presence of additional identical elements in the process, method, article, or apparatus that includes the element.

### Embodiment 1

As shown in FIG. 1, this embodiment of the disclosure provides a flowchart of an image generation method, which includes the following steps:
S101: Obtaining density information by a target model corresponding to a target scene space.

Where, the target model is trained to output viewpoint images corresponding to any viewpoint in the target scene space when a viewpoint is input. The density information is the rendering parameter required for image rendering by the target model and represents transparency of a point in the target scene space.

In some examples, the target model generates viewpoint images by volume rendering, and the density information is voxel density.

In some examples, the target model may be a Neural Radiance Field (NeRF) model. The NeRF model may be used to characterize a mapping between a shooting position, a shooting direction, and color and optical density of a plurality of points in the target scene space, and the color and optical density of the plurality of points in the NeRF model may support viewing from a new viewpoint. Based on the functional characteristics of the NeRF model, a specified viewpoint image corresponding to a designated viewpoint may be rendered by the NeRF model, thereby obtaining images of the target scene space from different viewpoints.

In one possible embodiment, the target model is trained using a training dataset. The training dataset includes images of the target scene space taken from a plurality of viewpoints using a capturing device.

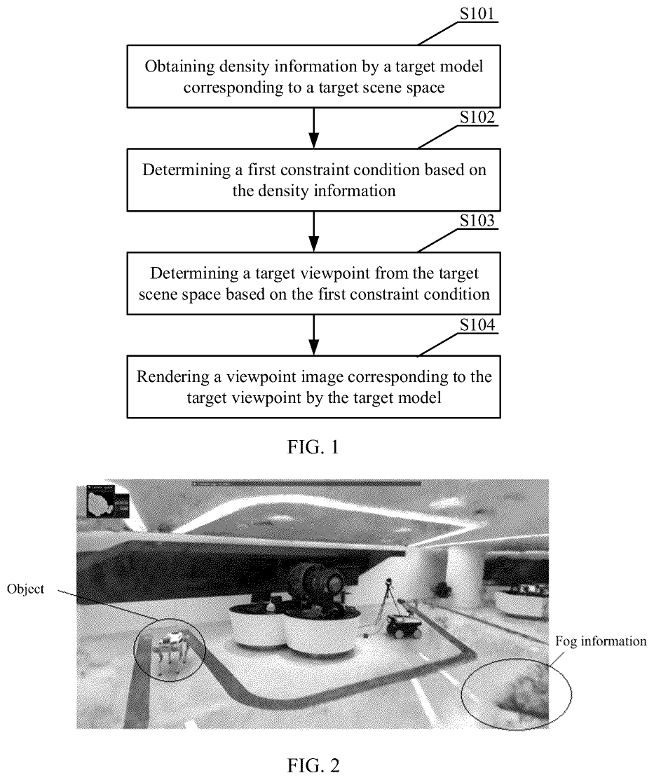

In one possible embodiment, a specific form of an image rendered by a target model for a target scene space can be seen in FIG. 2.

In some examples, transparency of a point in a target scene space may be expressed based on a density value of the point. The so-called density value reflects the probability of an object appearing at a point. Generally, the transparency of a point where the object appears will be lower, and vice versa, the transparency of a point where the object does not appear will be higher. In practical applications, the smaller the density value of the point, the lower the probability of the object appearing at the point, and the larger the density value of the point, the greater the probability of the object appearing at the point.
S102: Determining a first constraint condition based on the density information.

Where, the target scene space involves objects which are typically the focus of the image, and it should be ensured that all objects are present in the viewpoint image. During the process of rendering a viewpoint image corresponding to a specified viewpoint using the target model, it is necessary to determine a target viewpoint in the target scene space. The quality of the target viewpoint affects the quality of the final viewpoint image. A high-quality viewpoint image may clearly present the entirety of objects in the target scene space, while a poor-quality viewpoint image may omit or fail to capture the object in the target scene space. Therefore, in order to ensure the generation of a high-quality viewpoint image, a first constraint condition is set for the selection of the target viewpoint, and the first constraint condition is used to ensure that the optimal target viewpoint is determined from the target scene space.

In related technology, the trained target model includes the target scene space and the scene boundary. Points on the scene boundary are usually invalid points. As shown in FIG. 2, the scene boundary may be regarded as fog information in the target scene space. The fog information is an explicit manifestation of the density information. If the target viewpoint is determined within the fog information, the resulting viewpoint image will omit objects in the target model (or the entire visual effect of the viewpoint image will be unclear, making it difficult to discern objects). Therefore, in the process of selecting the target viewpoint, the target viewpoint should be avoided within the fog information.

Moreover, determining the target viewpoint on objects may also lead to defects in the corresponding viewpoint image, such as parts of the objects being omitted in the viewpoint image, making it impossible to present the entire objects in the viewpoint image. To ensure the quality of the viewpoint image, determining the target viewpoint on objects should also be avoided.

It is understandable that to avoid determining the target viewpoint on fog information and/or the object, it is necessary to determine the locations of fog information and/or the object in the target scene space. These locations are then designated as restricted points to avoid determining the target viewpoint based on these restricted points.

In some examples, the density information includes density values for a plurality of points in the target scene space. Using the density values of these points, the restricted points where objects and/or fog information are located in the target scene space may be effectively determined. By defining the restricted space formed by all restricted points as a first constraint condition, it is possible to avoid determining the target viewpoint on objects and/or fog information.

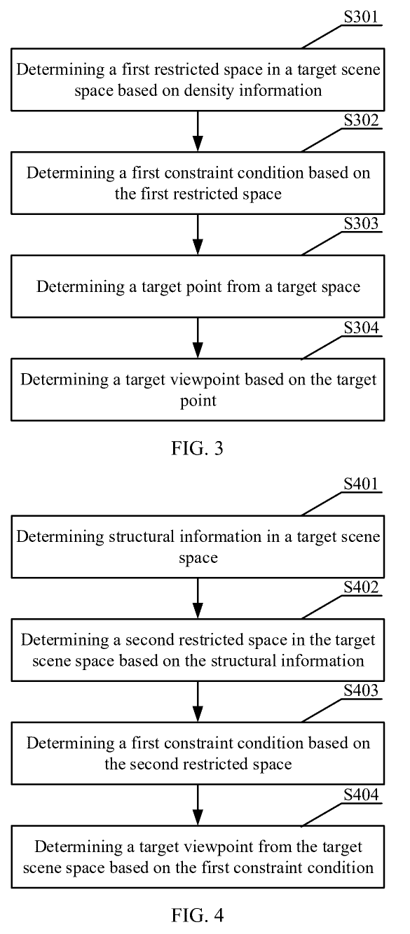

Optionally, the process of determining the first constraint condition based on density information to avoid determining the target viewpoint on fog information may be seen in the steps shown in FIG. 3 and the corresponding explanations.

Optionally, the process of determining the first constraint condition based on density information to avoid determining the target viewpoint on objects can be seen in the steps shown in FIG. 4 and the corresponding explanations.

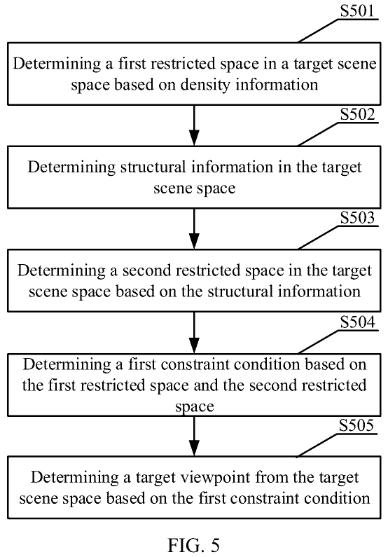

Optionally, the process of determining the first constraint condition based on density information to avoid determining the target viewpoint on fog information and object entities can be seen in the steps shown in FIG. 5 and the corresponding explanations.

It should be noted that the first constraint condition, besides being based on the restricted space in the target scene space, may also be expressed in the form of a density threshold limitation. The density threshold limitation involves analyzing whether any point in the target scene space meets a condition to serve as a target point based on the density threshold limitation, thereby determining the target viewpoint at points where the density value satisfies the density threshold limitation, effectively avoiding the determination of the target viewpoint on fog information and/or objects.

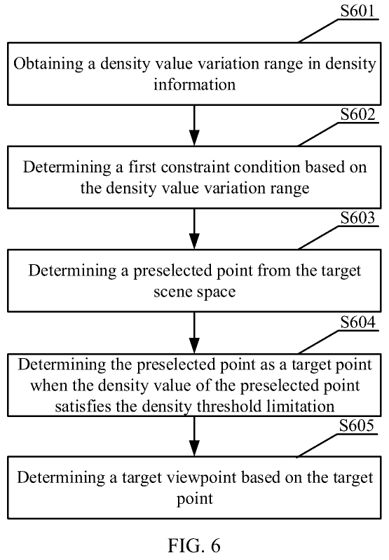

Optionally, the process of determining the first constraint condition based on density information to determine the target point whose density value satisfies the density threshold limitation can be seen in the steps shown in FIG. 6 and the corresponding explanations.
S103: Determining a target viewpoint from the target scene space based on the first constraint condition.

Where the first constraint condition limits the selection space for the target viewpoint, avoiding the determination of the target viewpoint on fog information and/or objects. This ensures that the subsequent viewpoint image will not omit objects in the target scene space and that the viewpoint image will clearly present the entirety of objects.

It should be noted that the first constraint condition essentially restricts the selection space for the target point. A reasonable target point ensure a reasonable target viewpoint. In related technology, multiple viewpoints may be determined based on the target point. Not all viewpoints on the target point may ensure that the corresponding viewpoint image is free of defects. Therefore, further filtering of the multiple viewpoints on the target point is necessary to ensure that a reasonable target viewpoint is obtained, such that the corresponding viewpoint image has no defects.

In some examples, the influence of the viewpoint on the viewpoint image is mainly reflected in the rendering effect. A reasonable target viewpoint may ensure that the rendering effect of the corresponding viewpoint image satisfies the specified requirements. Furthermore, the rendering effect of the viewpoint image is often affected by the depth value for the viewpoint. Therefore, the depth value for the viewpoint may be analyzed to determine whether any viewpoint can serve as the target viewpoint, ensuring a high-quality viewpoint image.

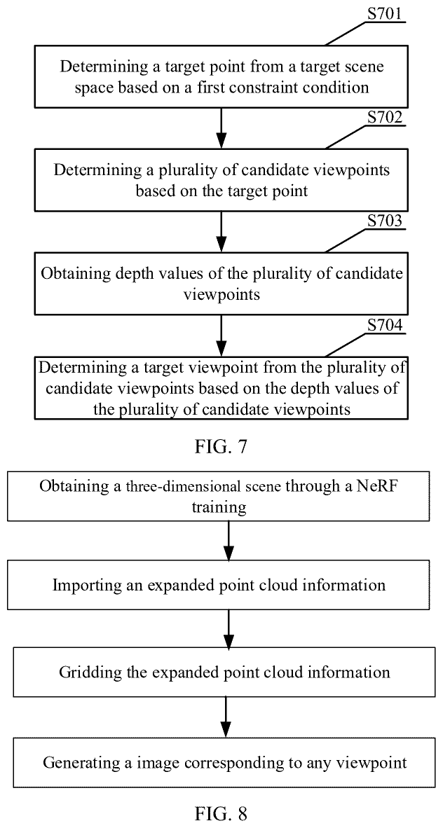

Optionally, the specific process for determining the target viewpoint from the target scene space based on the first constraint condition can also be seen in the steps shown in FIG. 7 and the corresponding explanations.
S104: Rendering a viewpoint image corresponding to the target viewpoint by the target model.

Where, the target model renders the viewpoint image corresponding to the target viewpoint, allowing images of the target scene space to be obtained from different angles.

In one possible embodiment, one target viewpoint is determined for one target point. The first constraint condition determines m target points, and m target viewpoints are determined based on the m target points. The viewpoint images corresponding to the m target viewpoints are rendered by the target model.

In one possible embodiment, n target viewpoints are determined for one target point. The first constraint condition determines m target points, and m×n target viewpoints are determined based on the m target points. The viewpoint images corresponding to the m×n target viewpoints are rendered by the target model.

In one possible embodiment, n target viewpoints are determined for one target point, and the first constraint condition determines one target point. n target viewpoints are determined based on the one target point. The viewpoint images corresponding to the n target viewpoints are rendered by the target model.

The flow in S101-S104 shows that the first constraint condition based on density information is used to determine the target viewpoint, avoiding determining the target viewpoint on fog information and/or objects. This ensures that the viewpoint image corresponding to the target viewpoint is free of defects and that the viewpoint image may clearly and fully present the objects in the target scene space, thereby effectively improving the quality of the viewpoint image.

### Embodiment 2

As shown in FIG. 3, a flowchart of another image generation method provided in an embodiment of the disclosure is illustrated, which includes the following steps:
S301: Determining a first restricted space in a target scene space based on density information.

Where, density values of points in the first restricted space are greater than a first density threshold.

In related technology, the density value of a point is greater than the first density threshold, indicating that the point is a restricted point where fog information is located. The density value of a point is not greater than the first density threshold, indicating that the point is not where fog information is located.

In some examples, the density information includes the density values of a plurality of points in the target scene space. By comparing the density values of the plurality of points with the first density threshold, the first restricted space in the target scene space may be determined. This first restricted space may be regarded as the point space where the fog information is located.

Additionally, aside from fog information, determining the target point on edge information of objects in the target scene space (such as walls and ceilings) results in poor-quality viewpoint images. Generally, the edge information is too close to the surface of the objects, leading to significant defects in the final viewpoint image (e.g., the viewpoint image may fail to show the entirety of the objects or may omit individual objects). Therefore, it is also necessary to avoid determining the target viewpoint on the edge information of objects.

In some examples, the density value of a point where the edge information is located in the target scene space is greater than the density value of a point where fog information is located, but smaller than the density value of a point where objects are located. Therefore, based on the density information, the point space where the edge information is located can be determined. Based on the point space of the edge information and the fog information, the first restricted space can be determined to avoid determining the target point on the fog information and the edge information.

In one possible embodiment, the average density value of the points where objects are located is usually greater than or equal to a second density threshold, and the second density threshold is greater than the first density threshold.

It can be understood that based on the average density value of the points where the objects are located, the density value of the points where the edge information is located is greater than the first density threshold but smaller than the second density threshold.

Optionally, based on the density information, the first restricted space in the target scene space is determined, where the density values of the points in the first restricted space are greater than the first density threshold but smaller than the second density threshold.

In some examples, by comparing the density values of the plurality of points with the first density threshold and the second density threshold, the first restricted space in the target scene space can be determined. This first restricted space is the point space where the fog information and/or edge information is located.
S302: Determining a first constraint condition based on the first restricted space.

Where, based on the first restricted space, the first constraint condition is determined. The first constraint condition may be regarded as: prohibiting the determination of the point in the first restricted space as the target point.

In related technology, during the process of rendering the viewpoint image corresponding to the target viewpoint by the target model, the constraints on the target viewpoint are usually not considered, which causes the target viewpoint to be located on fog information and/or edge information, resulting in significant defects in the final viewpoint image. Therefore, by determining the first constraint condition based on the first restricted space, defects in the viewpoint image may be effectively avoided, and the quality of the viewpoint image can be improved.
S303: Determining a target point from a target space.

Where, the target space is a space in the target scene space excluding the first restricted space.

It can be understood that determining the target point from the target space essentially means selecting a point from the target space as the target point, avoiding the determination of a point in the first restricted space as the target point. This prevents the target viewpoint from being determined on objects and/or fog information, effectively improving the quality of the viewpoint image.

In some examples, there may be at least one point in the target space, and one or more target points may be determined based on the actual situation.

In some examples, determining the target point from the target space may be understood as: determining the target space in the target scene space according to the first constraint condition, and then determining the target point from the target space.
S304: Determining a target viewpoint based on the target point.

Where, once the target point is determined, the target viewpoint may be determined based on the target point. In the process of rendering a viewpoint image by the target model, not only the target viewpoint but also the target point are needed. The target point is equivalent to a observation position. This rendering process may be understood as a camera shooting, where the target point is equivalent to the camera placement position, and the target viewpoint is equivalent to the camera shooting direction.

Optionally, multiple viewpoints may be determined for the same target point. How to further filter more appropriate target viewpoints from multiple viewpoints may be seen in the steps shown in FIG. 7 and the corresponding explanations.

The flow in S301-S304 shows that based on density information, the first restricted space corresponding to the fog information in the target scene space is determined, and the first constraint condition is determined based on the first restricted space to avoid determining the target point on fog information. This effectively improves the quality of the viewpoint image.

### Embodiment 3

As shown in FIG. 4, a flowchart of another image generation method provided in an embodiment of the disclosure is illustrated, which includes the following steps:
S401: Determining structural information in a target scene space.

Where, the types of structural information may include, but are not limited to, point cloud information, mesh information, and other three-dimensional representation information.

Generally, by loading three-dimensional representation data (e.g., point cloud data, mesh data) into the target model corresponding to the target scene space, the structural information in the target scene space may be obtained. In related technology, the structural information in the target scene space may typically represent objects in the target scene space.

In some examples, determining the structural information in the target scene space essentially means determining the point space where the objects are located in the target scene space.
S402: Determining a second restricted space in the target scene space based on the structural information.

Where, to avoid determining the target viewpoint on the objects, which would degrade the quality of the viewpoint image, the second restricted space is determined from the target scene space based on the structural information.

In some examples, the point space indicated by the structural information is determined as the second restricted space.

Additionally, determining a target point on the edge information of objects (e.g., walls and ceilings) causes the final viewpoint image to fail to display the entirety of the objects, as the edge information is too close to the surface of the objects. Therefore, it is also necessary to avoid determining the target viewpoint on the edge information.

In some examples, an expansion algorithm may be used to expand the structural information, resulting in an expanded space larger than the point space indicated by the structural information, which still includes the point space indicated by the structural information. Based on the expanded space, the second restricted space may be determined.

Optionally, the second restricted space includes both the structured information area in the target scene space and an unstructured information area within a specific distance from the structured information area.

It may be understood that the structured information area in the target scene space refers to the point space indicated by the structural information. The unstructured information area within a specific distance from the structured information area refers to the expanded space obtained by expanding the structural information. This expanded space includes the additional point space beyond the point space indicated by the structural information.

It should be noted that since the second restricted space includes both the structured information area and the unstructured information area, prohibiting the determination of a target point in the second restricted space effectively prevents determining the target point on objects or their edge information, ensuring the acquisition of high-quality viewpoint images.
S403: Determining a first constraint condition based on the second restricted space.

Where the first constraint condition is determined based on the second restricted space, which may be regarded as: prohibiting the determination of a point in the second restricted space as target point.

In related technology, during the process of rendering viewpoint images corresponding to the target viewpoint by the target model, constraints on the target viewpoint are usually not considered, causing the target viewpoint to be positioned on the objects, leading to viewpoint images that fail to display the entirety of the objects. Therefore, based on the second restricted space, the first constraint condition is determined to improve the quality of the viewpoint images.
S404: Determining a target viewpoint from the target scene space based on the first constraint condition.

Where, determining the target viewpoint from the target scene space based on the first constraint condition may be understood as: determining a selection space for the target point as a space in the target scene space excluding the second restricted space. After selecting the target point from the selection space, the target viewpoint is determined based on the target point.

Optionally, multiple viewpoints may be determined for the same target point. How to further filter more appropriate target viewpoints from multiple viewpoints may be seen in the steps shown in FIG. 7 and the corresponding explanations.

In one possible embodiment, the process for generating viewpoint images based on the flow shown in S401-S404 may be briefly summarized by a method shown in FIG. 8. The method is as follows: obtaining a target model corresponding to a three-dimensional scene (where the three-dimensional scene is a target scene space) by a NeRF algorithm training; importing an expanded structural information (e.g., point cloud information) into the target model; gridding the expanded point cloud information to obtain a second restricted space in the target scene space; and determining a first constraint condition based on the second restricted space, determining a target viewpoint from the target scene space based on the first constraint condition, and rendering a viewpoint image corresponding to the target viewpoint by the target model.

The flow shown in S401-S404 determines the second restricted space in the target scene space based on the structural information. The first constraint condition is determined based on the second restricted space to avoid determining a target point on an object, ensuring that the viewpoint image may display the entirety of the object and thereby effectively improving the quality of the viewpoint images.

### Embodiment 4

As shown in FIG. 5, a flowchart of another image generation method provided in an embodiment of the disclosure is illustrated, which includes the following steps:
S501: Determining a first restricted space in a target scene space based on density information.

Where, the specific implementation process and execution principle of S501 may refer to the steps and explanations of S301 in the above embodiments.
S502: Determining structural information in the target scene space.

Where, the specific implementation process and execution principle of S502 may refer to the steps and explanations of S401 in the above embodiments.
S503: Determining a second restricted space in the target scene space based on the structural information.

Where, the specific implementation process and execution principle of S503 may refer to the steps and explanations of S402 in the above embodiments.
S504: Determining a first constraint condition based on the first restricted space and the second restricted space.

Where, the first constraint condition is determined based on the first restricted space and the second restricted space, and the first constraint condition may be regarded as: prohibiting the determination of a point in the first restricted space and the second restricted space as a target points.

It should be noted that determining the first constraint condition based on the first restricted space and the second restricted space may avoid determining the target viewpoint on fog-like information and objects, effectively preventing the viewpoint image from missing or omitting objects in the target scene space, thereby significantly improving the quality of the viewpoint image.
S505: Determining a target viewpoint from the target scene space based on the first constraint condition.

Where, determining the target viewpoint from the target scene space based on the first constraint condition may be understood as: determining a selection space for the target point as a space in the target scene space excluding the first restricted space and the second restricted space. After selecting the target point from the selection space, the target viewpoint is determined based on the target point.

Optionally, multiple viewpoints may be determined for the same target point. How to further filter more appropriate target viewpoints from multiple viewpoints may refer to the steps and explanations shown in FIG. 7.

The flow shown in S501-S505, based on the density information, determines the first restricted space in the target scene space, and based on the structural information, determines the second restricted space in the target scene space. The first constraint condition for the target point is determined based on the first restricted space and the second restricted space, avoiding the determination of a target point on fog-like information and objects, and preventing the viewpoint image from missing or omitting objects in the target scene space, thereby effectively improving the quality of the viewpoint image.

### Embodiment 5

As shown in FIG. 6, a flowchart of another image generation method provided in an embodiment of the disclosure is illustrated, which includes the following steps:
S601: Obtaining a density value variation range in density information.

Where, the density value variation range includes but is not limited to: a minimum density value, a maximum density value, and a normal distribution of a density value of any point in a target scene space.
S602: Determining a first constraint condition based on the density value variation range.

Where, determining the first constraint condition based on the density value variation range may be understood as: within the density value variation range, determining a density threshold limitation, which is used to distinguish whether a point meets a condition for serving as a target point.

In some examples, points in the target scene space that may serve as target points have common characteristics. Based on the minimum density value, the maximum density value, and the normal distribution of the density value of any point in the target scene space, the common characteristics may be identified and regarded as the density threshold limitation, which is then used to determine whether a point meets the condition for serving as the target point.

It should be noted that a specific first constraint condition determined based on the density value variation range may be: the density value of a point satisfies the density threshold limitation.
S603: Determining a preselected point from the target scene space.

Where, the target scene space includes a plurality of points, and any point in the target scene space may be selected one by one as the preselected point.
S604: Determining the preselected point as a target point when the density value of the preselected point satisfies the density threshold limitation.

Where, after determining the preselected point, it is judged whether the density value of the preselected point satisfies the density threshold limitation. When the density value of the preselected point satisfies the density threshold limitation, the preselected point is determined as the target point. When the density value of the preselected point does not satisfy the density threshold limitation, the next preselected point is determined from the target scene space for density value analysis and judgment until the specified number of the target point is obtained.
S605: Determining a target viewpoint based on the target point.

Where, determining the target viewpoint based on the target point may be understood as: preselected points are repeatedly determined from the target scene space, and the density values of the obtained preselected points are continuously analyzed and judged until the specified number of the target point is determined. Then, based on the determined target point, the target viewpoint is determined.

Optionally, multiple viewpoints can be determined for the same target point. How to further filter out the most appropriate target viewpoints from multiple viewpoints may be referred to the steps and explanations shown in FIG. 7.

The flowchart of S601-S605 illustrates that the density threshold limitation is determined based on the density information, and the first constraint condition is determined based on the density threshold limitation, ensuring that the target viewpoint is generated on a reasonable target point, avoiding defects in the viewpoint image caused by selecting an inappropriate target viewpoint, thereby effectively improving the quality of the viewpoint image.

### Embodiment 6

As shown in FIG. 7, a flowchart of another image generation method provided in an embodiment of the disclosure is illustrated, which includes the following steps:
S701: Determining a target point from a target scene space based on a first constraint condition.

Where the number of the target point may be one or more.
S702: Determining a plurality of candidate viewpoints based on the target point.

Where, the directions and number of candidate viewpoints can be set according to actual conditions. In one possible embodiment, a random generation algorithm may be used to generate a plurality of candidate viewpoints at the target point.
S703: Obtaining depth values for the plurality of candidate viewpoints.

Where, the depth value is used to indicate a distance between the candidate viewpoint and an object in the target scene space.

In some examples, the depth values for the plurality of candidate viewpoints may be determined by a target model.
S704: Determining a target viewpoint from the plurality of candidate viewpoints based on the depth values for the plurality of candidate viewpoints.

Where, the depth value for the target viewpoint satisfies a depth value requirement.

It may be understood that the depth value satisfying the depth value requirement indicates that a viewpoint image corresponding to the target viewpoint has no defects. Generally, the depth value requirement may be analyzed and determined based on a large number of sample data (i.e., viewpoint images corresponding to different viewpoints).

The flowchart of S701-S704 illustrates that based on the target point, the selection space for the target viewpoint is further restricted, avoiding rendering viewpoint images from unreasonable viewpoints, ensuring that the viewpoint image corresponding to the target viewpoint has no defects, thereby improving the quality of the viewpoint image.

### Embodiment 7

Corresponding to the image generation methods provided in the above embodiments, an embodiment of the disclosure also provides an image generation apparatus.

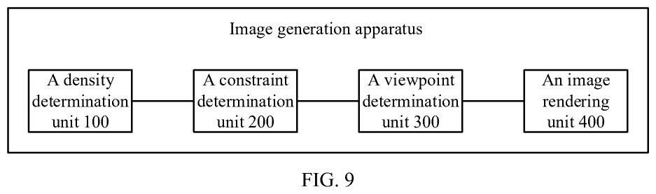

As shown in FIG. 9, an architecture diagram of the image generation apparatus provided in this embodiment of the disclosure is illustrated, which includes the following units:

A density determination unit 100, configured to obtain the density information by the target model corresponding to the target scene space, Where the target model is trained to output a viewpoint image corresponding to any viewpoint in the target scene space, and the density information is the rendering parameter required by the target model for image rendering, representing transparency of a point in the target scene space.

A constraint determination unit 200, configured to determine the first constraint condition based on the density information.

Optionally, the constraint determination unit 200 is specifically configured to: determine the first restricted space in the target scene space based on the density information, where the density values of points in the first restricted space are greater than the first density threshold; and determine the first constraint condition based on the first restricted space.

Optionally, the constraint determination unit 200 is specifically configured to: determine the structural information in the target scene space; determine the second restricted space in the target scene space based on the structural information; and determine the first constraint condition based on the first restricted space and the second restricted space.

Optionally, the second restricted space includes the structured information area in the target scene space and the unstructured information area within a specific distance from the structured information area.

Optionally, the constraint determination unit 200 is specifically configured to: obtain the density value variation range from the density information; and determine the first constraint condition based on the density value variation range.

A viewpoint determination unit 300, configured to determine the target viewpoint from the target scene space based on the first constraint condition.

Optionally, the viewpoint determination unit 300 is specifically configured to: determine target points from the target space, where the target space is a space in the target scene space excluding the first restricted space; and determine the target viewpoint based on the target points.

Optionally, the density values of the points in the first restricted space are less than the second density threshold, and the second density threshold is greater than the first density threshold.

Optionally, the viewpoint determination unit 300 is specifically configured to: determine preselected points from the target scene space; determine the preselected points as target points when the density values of the preselected points meet the density threshold limitation; and determine the target viewpoint based on the target points.

Optionally, the viewpoint determination unit 300 is specifically configured to: determine target points from the target scene space based on the first constraint condition; determine a plurality of candidate viewpoints based on the target points; obtain depth values for the plurality of candidate viewpoints, where the depth values are used to represent distances between the candidate viewpoints and an object in the target scene space; determine the target viewpoint from the plurality of candidate viewpoints based on the depth values for the plurality of candidate viewpoints, where a depth value for the target viewpoint satisfies a depth value requirement.

An image rendering unit 400, configured to render the viewpoint image corresponding to the target viewpoint by the target model.

The units described above determine the first constraint condition for the target viewpoint based on the density information, preventing the determination of the target viewpoint on fog-like information and/or objects, ensuring that the viewpoint image corresponding to the target viewpoint is free of defects. This allows the viewpoint image to clearly and completely display the objects in the target scene space, thereby effectively improving the quality of the viewpoint image.

This disclosure also provides a computer-readable storage medium, where the computer-readable storage medium includes a stored program, and the program execute the image generation methods provided in the present disclosure.

This disclosure further provides an electronic device, including: a processor, a memory and a bus. The processor is connected to the memory through the bus, the memory is used to store the program, and the processor is used to run the program, where the program execute the image generation methods provided in the present disclosure during operation.

In addition, the functions described in this embodiment of the disclosure may at least partially be executed by one or more hardware logic components. For example, without limitation, exemplary types of hardware logic components that may be used include: field-programmable gate arrays (FPGA), application-specific integrated circuits (ASIC), application-specific standard products (ASSP), system on chip (SOC), complex programmable logic devices (CPLD), etc.

Although the subject matter has been described using language specific to structural features and/or methodical actions, it should be understood that the subject matter defined in the appended claims is not necessarily limited to the specific features or actions described above. Instead, the specific features and actions described above are merely illustrative forms for implementing the claims.

Although several specific implementation details have been included in the above discussion, these should not be construed as limitations on the scope of the disclosure. Certain features described in the context of separate embodiments may also be implemented together in a single embodiment. Conversely, various features described in the context of a single embodiment may also be implemented separately or in any suitable sub-combination in multiple embodiments.

The above description is only a preferred embodiment of this disclosure and an explanation of the applied technical principles. Those skilled in the art should understand that the scope of this disclosure is not limited to the specific combinations of the technical features mentioned above, but also covers other technical solutions formed by any combination of the technical features or their equivalents that do not depart from the disclosed concepts. For example, the above-mentioned features may be replaced with similar functional technical features disclosed in this application (not limited to) to form technical solutions.

What is claimed is:

1. An image generation method, comprising:
obtaining density information by a target model corresponding to a target scene space, wherein
the target model is trained to output a viewpoint image corresponding to any viewpoint after inputting the any viewpoint in the target scene space; and
the density information is a rendering parameter required for image rendering by the target model, and the density information represents transparency of a point in the target scene space;
determining a first constraint condition based on the density information;
determining a target viewpoint from the target scene space based on the first constraint condition; and
rendering a viewpoint image corresponding to the target viewpoint by the target model.

2. The method according to claim 1, wherein determining the first constraint condition based on the density information comprises:
determining a first restriction space in the target scene space based on the density information,
wherein a density value of a point in the first restriction space is greater than a first density threshold; and
determining the first constraint condition based on the first restriction space.

3. The method according to claim 2, wherein determining the target viewpoint from the target scene space based on the first constraint condition comprises:
determining a target point from a target space,
wherein the target space is a space in the target scene space excluding the first restriction space; and
determining the target viewpoint based on the target point.

4. The method according to claim 2, wherein the density value of the point in the first restriction space is less than a second density threshold, and the second density threshold is greater than the first density threshold.

5. The method according to claim 2, wherein determining the first constraint condition based on the first restriction space comprises:
determining structural information in the target scene space;
determining a second restriction space in the target scene space based on the structural information; and
determining the first constraint condition based on the first restriction space and the second restriction space.

6. The method according to claim 5, wherein the second restriction space comprises a structured information area in the target scene space and an unstructured information area within a specific distance from the structured information area.

7. The method according to claim 1, wherein
the first constraint condition is that a density value of a point satisfies a density threshold limitation; and
determining the target viewpoint from the target scene space based on the first constraint condition comprises:
determining a preselected point from the target scene space;
determining the preselected point as a target point when a density value of the preselected point satisfies the density threshold limitation; and
determining the target viewpoint based on the target point.

8. The method according to claim 7, wherein determining the first constraint condition based on the density information comprises:
obtaining a density value variation range from the density information; and
determining the first constraint condition based on the density value variation range.

9. The method according to claim 1, wherein determining the target viewpoint from the target scene space based on the first constraint condition comprises:
determining a target point from the target scene space based on the first constraint condition;
determining a plurality of candidate viewpoints based on the target point;
obtaining depth values for the plurality of candidate viewpoints, and the depth values are used to represent distances between the plurality of candidate viewpoints and an object in the target scene space; and
determining the target viewpoint from the plurality of candidate viewpoints based on the depth values for the plurality of candidate viewpoints,
wherein a depth value for the target viewpoint satisfies a depth value requirement.

10. An electronic device, comprising one or more processors and a memory containing a computer program that, when being executed, causes the one or more processors to:
obtain density information by a target model corresponding to a target scene space, wherein the target model is trained to output a viewpoint image corresponding to any viewpoint after inputting the any viewpoint in the target scene space, and the density information is a rendering parameter required for image rendering by the target model, and the density information represents transparency of a point in the target scene space;
determine a first constraint condition based on the density information;
determine a target viewpoint from the target scene space based on the first constraint condition; and
render a viewpoint image corresponding to the target viewpoint by the target model.

11. The device according to claim 10, wherein the one or more processors are further configured to:
determine a first restricted space in the target scene space based on the density information,
wherein a density value of a point in the first restricted space is greater than a first density threshold; and
determine the first constraint condition based on the first restricted space.

12. The device according to claim 11, wherein the one or more processors are further configured to:
determine structural information in the target scene space;
determine a second restricted space in the target scene space based on the structural information; and
determine the first constraint condition based on the first restricted space and the second restricted space,
wherein the second restricted space comprises a structured information area in the target scene space and an unstructured information area within a specific distance from the structured information area.

13. The device according to claim 10, wherein the one or more processors are further configured to:
obtain a density value variation range from the density information; and
determine the first constraint condition based on the density value variation range.

14. The device according to claim 10, wherein the one or more processors are further configured to:
determine a target point from a target space, wherein the target space is a space in the target scene space excluding a first restricted space, and a density value of a point in the first restricted space is greater than a first density threshold; and
determine the target viewpoint based on the target point.

15. The device according to claim 10, wherein the one or more processors are further configured to:
determine a preselected point from the target scene space;
determine the preselected point as a target point when a density value of the preselected point satisfies a density threshold limitation; and
determine the target viewpoint based on the target point.

16. The device according to claim 10, wherein the one or more processors are further configured to:
determine a target point from the target scene space based on the first constraint condition;
determine a plurality of candidate viewpoints based on the target point;
obtain depth values for the plurality of candidate viewpoints,
wherein the depth values are used to represent distances between the plurality of candidate viewpoints and an object in the target scene space; and
determine the target viewpoint from the plurality of candidate viewpoints based on the depth values for the plurality of candidate viewpoints,
wherein a depth value for the target viewpoint satisfies a depth value requirement.

17. A non-transitory computer-readable storage medium storing a computer program that, when being executed, causes at least one processor to perform:
obtaining density information by a target model corresponding to a target scene space, wherein
the target model is trained to output a viewpoint image corresponding to any viewpoint after inputting the any viewpoint in the target scene space; and
the density information is a rendering parameter required for image rendering by the target model, and the density information represents transparency of a point in the target scene space;
determining a first constraint condition based on the density information;
determining a target viewpoint from the target scene space based on the first constraint condition; and
rendering the viewpoint image corresponding to the target viewpoint by the target model.

18. The non-transitory computer-readable storage medium according to claim 17, wherein the at least one processor is further configured to perform:
determining a first restriction space in the target scene space based on the density information,
wherein a density value of a point in the first restriction space is greater than a first density threshold; and
determining the first constraint condition based on the first restriction space.

19. The non-transitory computer-readable storage medium according to claim 18, wherein the at least one processor is further configured to perform:
determining a target point from a target space,
wherein the target space is a space in the target scene space excluding the first restriction space; and
determining the target viewpoint based on the target point.

20. The non-transitory computer-readable storage medium according to claim 18, wherein the density value of the point in the first restriction space is less than a second density threshold, and the second density threshold is greater than the first density threshold.
